(19) United States
(12) Patent Application Publication
(10) Pub. No.: US 2009/0186610 A1
(43) Pub. Date: Jul. 23, 2009

(54) METHOD FOR DETECTING EVENTS ON CELLULAR COMM. NETWORK

(76) Inventors: Ofer Avni, Gizo (IL); Yossi Kaplan, Rishon Lezion (IL)

Correspondence Address: SMITH FROHWEIN TEMPEL GREENLEE BLAHA, LLC, Two Ravinia Drive, Suite 700, ATLANTA, GA, 30346, US

(21) Appl. No.: 12/017,394

(22) Filed: Jan. 22, 2008

(51) Int. Cl. H04Q 7/20

(52) U.S. Cl. 455/425

(57) ABSTRACT

A system and method that detects related events in the cellular comm. network and its derivatives with minimum overhead and in a changing cellular environment, both in the installation stage of a system, as well as during continuous operation.

### TECHNICAL FIELD

This invention relates generally to detecting related events on the cellular comm. network for extracting data related to mobile phones and network conditions.

### BACKGROUND

A sporadic cellular comm. network event, such as dropped telecommunication call or quality related handover, can be caused by many factors, among which may be a problematic handset unit, temporary blocking element (e.g. a truck on the route), etc. solving each such event is practically impossible, and many time not important for network overall performance. Currently used systems to monitor network performance, provide the problems in cell-sector resolution, which means that problems from many routes, houses, elevators and basements are within the same cell sector, without the ability to differentiate a cluster of problems caused by a specific phenomena, thus without the ability to sort these problems by importance and without the ability to isolate the cause for each problem and solve it. Dropped telecommunication calls at a specific cell ‘A’, can be caused all around the cell coverage area and due to numerous reasons, and analyzing them as a group will not provide a solution in most cases. A specific point on a route may experience 20% dropped telecommunication calls, but it will never be noticed from cell sector statistics, such as number of dropped telecommunication calls, number of calls or average duration of calls, since the amount of calls influenced by the problem is negligible in comparison with the total number of problematic calls at that specific cell sector. There is a need to differentiate each specific problem in order to identify each repeating problem from other repeating and sporadic problems within the same cell sector, and by this isolate the impact and the exact reason for each repeating problem and fix it.

In every cellular comm. network there are many problems that are not caused due to lack of coverage, but due to network management problems such as wrong handover parameters or bad frequency allocation. These problems can be fixed without changing any hardware or deploying new antenna, just by adjusting network parameters.

Another method to monitor network performance is test drives that are used to detect problems in the network on the routes and solve them. Many times test drives can't detect a problem since its mobile unit equipment is different from the handsets used by a variety of mobile users. In addition, test drives only sample the routes and have low probability to detect problems (For example, to detect a severe drop that happens for 4% of the calls 25 test drives are required in average, and it will still look like a sporadic problem, and not persistent). Some of these problems may only appear in certain times due to network load or other temporary conditions, thus can't be observed by sporadic drive test.

U.S. patent application 20050163047 to McGregor, et al., teaches the use of messages from the cellular comm. network to detect and report on network problems. However, this method has the following limitations:
A special software/hardware needs to be installed in the handset
Only a small fraction of the handsets report their problems (you need to get approval from the user to use this software and violate its privacy, and the communication load involved is much too large for the network to function with)
The number of reporting phones is limited also since the reporting process is loading the cellular comm. network
   U.S. patent application 20050130645 also teaches a method that suffers from the same weaknesses.

The current invention teaches the ability of detection of the where about of mobile units over the route.

U.S. Pat. No. 5,657,487 to Kennedy teaches the use of handovers to determine vehicles velocity and the number of vehicles passing on a certain route. Kennedy does not teach or provide a solution to the very common problem in metropolitan areas of the same handovers relating to several different routes. This invention also discloses an extremely expensive implementation requiring RF receivers spread over the covered area.

In U.S. Pat. No. 6,459,695 to Schmitt the dropped telecommunication calls data and similar data is analyzed to determine coverage borders of cells. However, this method requires generating location information for each mobile all the time, in order to determine its location before the call was dropped and deduct the location of the dropped. Sending this data requires deploying location system at the cellular comm. network (like triangulation at the ABIS level) or at the handset (like GPS component) which are very expensive. In addition, sending all the location data to a central server is not realistic since the communication resources required by the network will shut down the cellular comm. network completely, and in many of the countries this is forbidden due to privacy violation. These methods are also not relevant for in-building events for many reasons: GPS receivers for example, have problem connecting to satellites from within buildings. Triangulation methods suffer from significant in-accuracy due to multi-path in buildings, etc.

In order to determine the exact where-about of the mobile phone in other patents, it is necessary to drive over the routes and record the data with location reference. Furthermore, if the cellular comm. network changes—the calibration should be repeated, otherwise the data will not be accurate as needed. This process requires a lot of overhead in installing and maintaining such a system.

In other patents, such as U.S. Pat. No. 6,516,195 to Zadeh, a location request is sent after the problem occurred. In such a method, incase of dropped telecommunication calls, the connection with the mobile unit will resume only after he moved away from the point of the dropped telecommunication call, and the location query will not be relevant any more in some cases. In addition, the events that led to the problem are not known and can't be analyzed to solve the problem. In many of the these cases, significant network resources are invested in detecting the location of each problem, while many of them are sporadic problems that will not require any change in the network, and these location resources were invested for nothing.

These limitations and others are addressed and solved by the current invention.

### SUMMARY OF THE INVENTION

The current invention describes a method to detect related and/or repeating events and other events on the cellular comm. network and use them to generate information about problems in the network, as well as about patterns of the mobile users.

In addition, the current invention describes a method to sort these problems by importance and solving them, some times by determining the where-about of a mobile phone and its derivatives with minimum overhead and in changing cellular environment, both in the installation stage of a system, as well as during continuous operation.

### BRIEF DESCRIPTION OF THE DRAWINGS

The disclosure is provided by way of non-limiting examples only, with reference to the accompanying drawings, wherein:

FIGS. 1A and 1B illustrate how theoretical sequences can be generated from mapping data.

FIGS. 2A and 2B show how a cluster can be correlated to a specific route.

FIG. 3 shows how stop light delay is measured.

FIG. 4 shows how sequences that led to dropped telecommunication calls are clustered to differentiate specific cluster of problems based on similarity algorithm.

### DESCRIPTION OF THE INVENTION

Detecting Related Events on the Cellular Comm. Network

An example of detecting related or repeating events is disclosed. A matching stage can be the first stage of the method. At this stage a sequences database is created, containing sequences of events extracted from the control channel of the cellular comm. network, (some times called also “signaling data”) which has a relevant characteristic. Such characteristic can be for example the appearance of dropped telecommunication call at the end of a sequence, the appearance of call quality problem (such as a handover for which the reported cause, specified within the message, is uplink or downlink quality) during the sequence, the appearance of specific cell or cells relevant for a required area, bandwidth problem or any other specific event of interest. Such events may include cell/sector ID, radio frequencies (which can be correlated with Cell/section), location area, service area etc. Additional information, for example neighboring cells, events causes, signal related data, etc., may be used in creation of this database. One purpose of using a certain type of sequences is to differentiate between events that are caused by a mobile unit in a moving vehicle, where the sequences that led to a repeating problem can be similar. At a later stage, when we fix such a problem, it will also fix similar problems for non moving handsets.

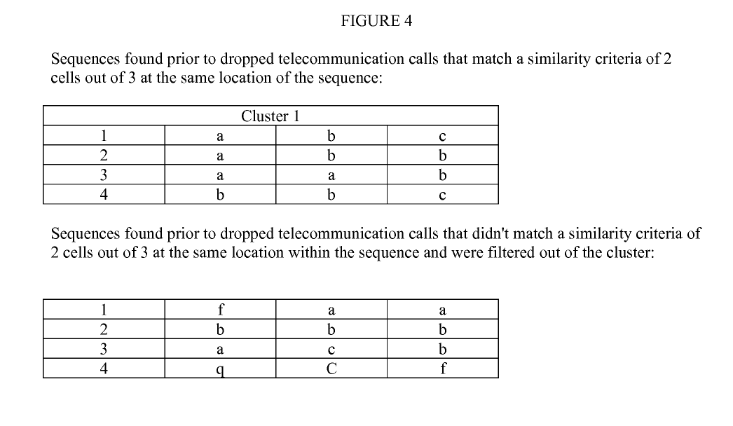

A similarity algorithm is then applied for this database, to look for clusters of similar sequences that relate to a specific event (see FIG. 4). The similarity algorithm is defined in a way that differentiates between different sequences, and in the same time does not filter out relevant sequences. For example, a cluster definition that includes all sequences of 2 specific signaling messages, A and B, is most likely to generate very large clusters, but these clusters will include many sequences that came from many places and do not necessarily point to a specific event/problem/location. On the other hand, a cluster definition that includes all sequences of 10 specific signaling messages, A, B, C, . . . I, J is most likely to generate few small clusters, each of them represent only one event/problem/location, but it is also most likely in such definition that many repeating problems will be filtered out and will not be observed at all. In cases the dropped telecommunication call message is not reported at the monitoring level of the system, the average duration of the calls, or the number of calls, each per a specific cluster may indicate that some of the calls were dropped, as well as on other problems of the network for that cluster. This method for detecting related and/or repeating events on the cellular network is one of the main embodiments of this invention since it saves a lot of resources in detecting important phenomena in the network at a much better resolution than a cell/sector resolution, and doesn't require any active queries that impose load on the cellular network. This method is described here only as an example and can be conducted in many ways. Similarity can be based on topological location, real location, sequence of events, specific parameter or data in the network or specific parameter or data external to the network or any other parameter or data or any combination of parameters and/or data. There are numerous applications that can be generated from these methods, some of which are described in this invention as examples only.

### Using the Clusters' Data to Identify the Importance of a Problem

Clusters with one sequence or low number of sequences are not important to the performance of the cellular system in most cases, and can be caused by problematic hand sets, or a singularity event, such as a truck blocking the reception at specific point.

Several parameters can be used to determine the importance of a problem based on the cluster data. Size of cluster (larger clusters are more important), type of event (dropped telecommunication calls are more important than call quality) etc. Another parameter to help determining the importance of a problem is the percentage of the sequences that led to the specific event out of the entire sequences in a cluster. For example the ratio of dropped telecommunication calls on a route can be found, out of all those calls that were correlated to the same cluster. In a specific embodiment of this invention the important clusters are detected and the non-important clusters are filtered out.

Using the Clusters' Data to Understand and/or Solve a Problem

In many cases, the data within the cluster is good enough to understand/determine the reason/s of the problem and solve it. In other cases the cluster data need to be coupled with data about elements in the cellular comm. network, or other types of data, in order to identify and solve the problem. For example, if a drop repeatedly occurs when the sequence of the call ends up with a handover from a specific cell (A) to a specific cell (B), and there are only few handovers like that are not related to this cluster as seen in the handover matrix (so disabling this handover will not heart the network elsewhere), than the allowed handovers list should be changed to forbid handovers from A to B. This can be understood from the cluster data alone in some cases, and requires other type of data in other cases, such as handover matrices or physical location of network elements, cell sector statistics etc. At this specific example, if mapping data shows that cell (B) is remotely located relative to cell (A), it can support the decision to disable the handover between them. Another example demonstrates that when a sequence including a poor quality message is repeatedly detected, and the cell site (C) experiencing poor quality within this sequence is using frequencies similar to a close by cell site (D), then the frequencies for one of these cell sites, (C) or (D) should be changed.

Since in many cases the operating people are not familiar with the method described in this invention, or other method for fixing the network, and they do not know how to use the data in order to solve a problem, a set of rules that will utilize the above information or other types of relevant information or also the other information described below can be used to create automatic recommendation on how to fix a problem. It is another embodiment of the present invention is to insert a set of rules to the method for analyzing the sequence information that led to a problem, sometimes in conjunction with other types of data, in order to automatically recommend a solution for the problem.

Since more and more parameters at the cellular comm. networks are controlled by a computer, and no physical field activity is required to change them, this automatic recommendation for changing the parameters of the cellular comm. network can be implemented automatically, with no need in manual involvement, or with only manual confirmation. It is another embodiment of the current invention to implement recommended changes automatically to cellular comm. networks.

There are other cases in which the data in the cluster and other types of data about the cellular comm. network is not enough to solve the problem, and other type of data is required, such as the location of the mobile unit when these events occurred.

In some cases the clusters can be intercepted with data regarding the type of handset in order to identify if handset type can be a reason for a problem, or for any other reason

Correlating Sequences of Cellular Location Events to a Specific Route without Loading the Cellular Comm. Network or Changing It in Any Way or Conducting Drive Rests

In some specific embodiments of the current invention, the data in the above database can be clustered, so that after collecting a statistical sample (e.g. few hours/days/weeks of data) an analysis is conducted to create clusters of similar sequences that are most likely generated on the same route. This analysis may be repeated in different stages and for different periods to identify changes in the cellular comm. network over time. This clusterization process can be done in various ways. One of the correlation procedures is to build each cluster with identical sequences only.

Each sequence in the database and/or each cluster of such sequences can be correlated to a mapping database containing data about the location of either elements or groups of elements in the cellular comm. network, such as cell towers and sector directions, location/service areas etc., or location of events or groups of events occurring in the cellular comm. network, such as handovers, frequency changes, location/service area changes etc., or any combination of such elements and/or events locations.

This correlation is used to identify the location of such sequences and/or clusters to specific areas and/or routes within the coverage area of the cellular comm. network.

Some simple embodiments of such mapping databases may be:
1. A map including locations of cell sites with sectors directions and/or coverage angle boundaries and/or frequencies within an area.
2. A map or database as in (1) including terrain topographic data, elevation points and buildings details.
3. A map or database as in (1) or (2) including dominant cell/sectors per location such as maps created by prediction algorithms.
4. a database including for specific roads the dominant cell/sectors per location on the road or per road section.
5. Synthetic sequences of events and their locations generated using data as in (1)-(3) above.
6. Sequences of events generated by correlating events on the cellular comm. network with their accurate location using methods such as test drives with a mobile phone and a positioning system such as GPS or Galileo system.

Such or other mapping databases and/or any combinations of them are used to match between each sequence and/or cluster to a possible route. In cases the matching procedure didn't provide unique correlation, the clusters' parameters can be changed in order to get unique correlation. Such a parameter can be the length of each sequence or the variance between the sequences.

The mapping database can be created before, during or after creating the sequences database. Furthermore, if we need to differentiate between several correlations or to locate specific events with higher location accuracy we may implement a method and/or combination of methods for a specific area and/or route section.

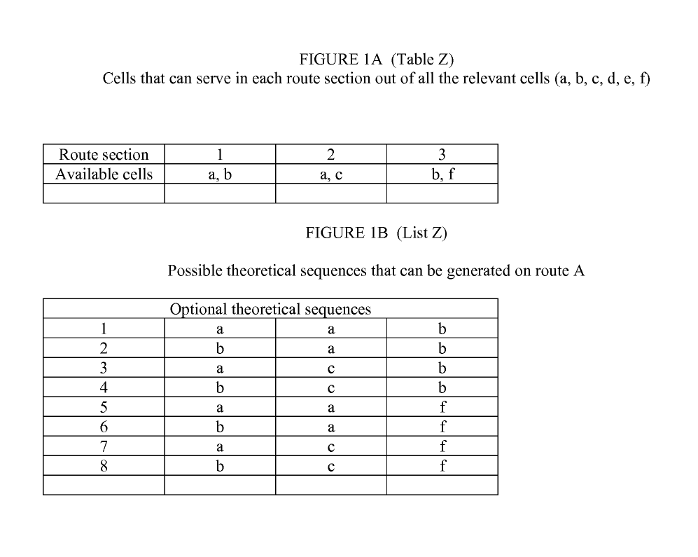

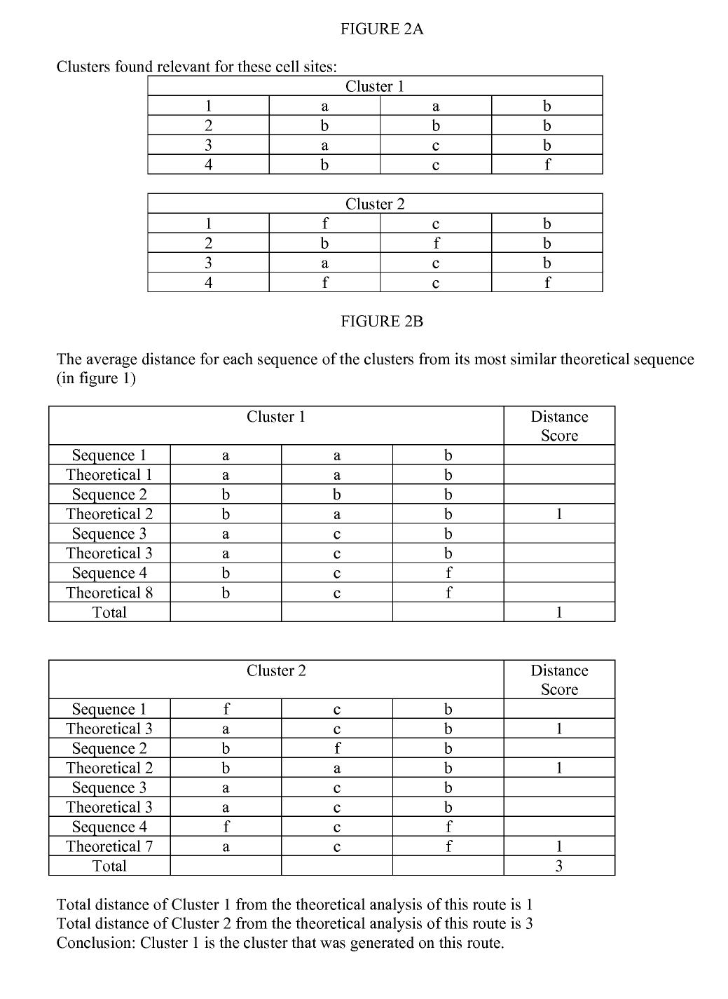

One example of a method to correlate route Z to a specific cluster out of 2 potential clusters is detailed in FIGS. 1 and 2. This can be as follows:
Divide the route Z to 3 small sections 1, 2 and 3, that do not overlap and together comprise the entire route Z
Per each section write down which cells are not blocked and can communicate with the mobile unit for the entire section. (Table Z—see FIG. 1A)
Create a list of all combinations of sequences that can be generated from table Z (list Z). Each sequence can be called “Theoretical Sequence”. (see FIG. 1B)
Provide a “distance score” for each sequence in the cluster (2 sample clusters are shown in FIG. 2A) in comparison to each possible sequence in list Z. This score can be measured by the number of cells that are in the same place for both sequences (see FIG. 2B)
Average the “distance score” for each cluster to determine its similarity to the route. If one cluster is more similar than the others (e.g. average distance score is twice than the other clusters)—announce them as correlated (see FIG. 2B).
If no clear differentiation is found between the clusters with regards to a specific route, than the clusterization rules should be refined and another set of clusters should be checked vs. the route.

It is a specific embodiment of the current invention, as described in this section, initially similar events are correlated to form a cluster, and only then the cluster is correlated to a specific route, rather than correlating each single sequence to a specific route, since a cluster of events will have much more correlation data to a route than a single event, thus the correlation can be much more accurate, and at the same time resources are not wasted for correlation of sporadic problems that will not require any change in the network.

Another embodiment of the current invention is to use in real time calls that were correlated to a specific cluster, and to query in real time parameters of this call or other parameters of the mobile phone to generate more information about the specific call or specific location or any other type of data. This way the load over the cellular comm. network is minimal since queries are conducted only to those calls that were correlated to a problematic cluster. As an example, one can query in real time calls that were correlated to a cluster of problematic events, and before the event occurs, to query in real time parameters of this call, such as location related parameters, call quality parameters, etc.

### Stationary Mobile Units, Slow Downs & Stop Lights

For stop lights, events on the cellular comm. network before the stop light and after the stop light can be automatically defined and monitored. By measuring the time difference between these events and deducting the time required to traverse this distance in free route, data about the stop light delay is generated.

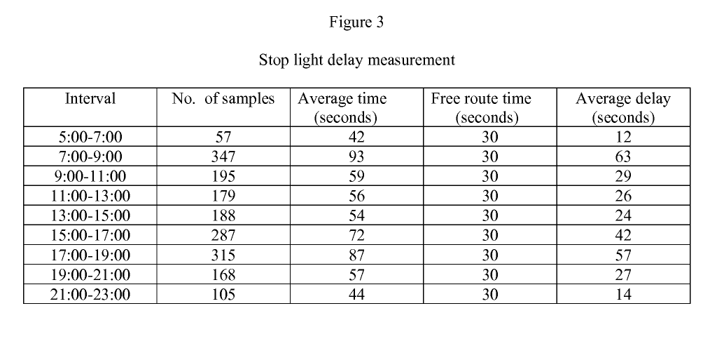

FIG. 3 shows the average stop lights delay sampled for 2 hour intervals during the day, it can be readily seen that delays are significantly higher in peak hours (morning and afternoon). This data can be accumulated over time and used for stop light follow-up and for real-time stop light calibration as well as for stop-light operation planning.

Using the Present Detection Methods to Detect Problems in the Cellular Comm. Network

Whenever we wish to detect the where-about of specific events on the cellular comm. network such as a dropped telecommunication call or problematic handover occurs, it is possible to detect the route which the mobile was passing on when the problem occurred, and where on the route it was at the time of the problem.

Each such problem can be analyzed in comparison with other problems on the same route to create cluster of problems that justifies an action from the cellular operators to fix it.

A cluster can be built by looking at all problems at a specific stretch over the route, or by time of day, or by a sequence of events that led to such problems, or any other parameter, or any combination of such parameters

Using Signaling Sequence to Detect a Problem at the Cellular Comm. Network and Solve It

Collecting low level signaling data (e.g. ABIS data—the link between the base station and the base station controller (BSC) or air interface—between the mobile and the base station) of a call and sending it to a central location through the cellular comm. network or through a dedicated network, either wireless or wire-line for monitoring purposes requires a lot of network resources, thus it is done only for a sample of the calls and within this sample only a for a short part of the call, and sometimes only after the problematic event happened. Test drives, on the other hand, monitor all data of a call for a long time, but only for that specific call and specific equipment. Many times problems sensed by different types of handsets and/or at different time and or different network load etc. will not be sensed by a sporadic test drive. It is another important embodiment of this invention to use only high level data such as data available on the A interface between the base station controller (BSC) and the Mobile switching system (MSC) to detect a network problem and solve it. Such data may include all type of layer three messages, such as handover reports with cell/sector data, handover cause, timing, information about dropped telecommunication calls etc. This way data can be reported during the entire call without loading the cellular comm. network for many calls concurrently, and even for all the calls, and when a problem occurs, this data can be used to detect the reason of the problem and solve it for many of the problems. An example for such a problem is a cell, which is remote from route A, that takes over a call conducted at that route. This event can lead to sequence of events that will cause a dropped telecommunication call after long time (tens of seconds and even minutes). The reason for this problem will not be detected by a sporadic test drive, neither by a short sampling of the call around the drop, and can be easily understood and fixed by the method in this invention.

Using Other Types of Data to Detect Events in the Cellular Comm. Network in Buildings

Whenever we wish to detect the where-about of specific events on the cellular comm. network which is in-buildings, the above method will not work properly. Other location methods are also not applicable for many reasons: GPS receivers for example, have problem connecting to satellites from within buildings. Triangulation methods suffer from significant in-accuracy due to multi-path in buildings, etc

Another important embodiment of the current invention, is to detect the location of dropped telecommunication calls and other network malfunctions in buildings. By looking at reports from the network on network malfunction during different times of the day, a correlation can be conducted between the problem and the building, and even the exact apartment in the building. As an example, dropped telecommunication calls at late evening times will be generated from home in many of the cases. By correlating dropped telecommunication calls reports of a specific subscriber with the known address of that subscriber during late evening's hours, one can identify if the specific building or apartment has a dropped telecommunication call problem. In order to fine tune the analysis, one can use only those dropped telecommunication calls which occurred at a specific cell or list of cells that serve the area of the building or apartment. The same can be done for offices by using cell phones which are used by companies during working hours and correlate it with their offices location

While the exemplary embodiment of the present method have been illustrated and described, it will be appreciated that various changes can be made therein without affecting the spirit and scope of the method. The scope of the method, therefore, is defined by reference to the following claims

1. A method to detect related events in a cellular comm. network, said method comprising of:
Extracting signaling data from the cellular comm. network
Clustering related events from the signaling data according to a similarity algorithm

2. The method according to claim 1 whereas the type of signaling data used is a sequence of messages on the control channel

3. The method according to claim 2 further comprising of analyzing a cluster to determined a common reason for a repeating network problem

4. The method according to claim 3 further comprising of solving the repeating network problem by changing a parameter in the network

5. The method according to claim 3 further comprising of creating a recommendation automatically for solving the repeating network problem by changing at least one parameter

6. The method according to claim 5 further comprising of implementing the change automatically.

7. A method as in claim 6, where as the automatic parameter change is subject to manual approval

8. The method according to claim 2 further comprising of querying a mobile phone in real time once a sequence related to this phone was correlated with a cluster

9. The method according to claim 2 further comprising of correlating a cluster with cellular comm. network elements data to identify a reason for network problem

10. The method according to claim 2, wherein analysis used to correlate signaling sequences from the cellular comm. network to a specific route section comprises of correlating each cluster to a specific route section by matching it with a mapping data base

11. The method of claim 10 wherein network problems identification further comprises of Correlating the clusters with cellular comm. network elements data

12. A method for correlating a vehicle with the route it passing on based on cellular communication, said method comprises:
Learning event sequences and correlating them to a specific route according to a map of the area;
Conducting analysis of new event sequences from new drives in conjunction with a learnt database to assign a route at certain time points to a mobile phone.

13. The method as in claim 12, wherein further analysis is conducted to detect clusters of problems in the cellular comm. network at a specific point on the route, said analysis comprises:
Sorting said problems by one or more parameters
Clustering said problems according to the output of the sorting process

14. A method for measuring a stop light delay comprises of:
Monitoring events on the cellular comm. network before the stop light and after the stop light
Measuring the time difference between these events
Deducting the time required to traverse this distance during free route from the measured time

15. A method for detecting the location of network malfunction and other types of events within a building, comprise of:
Monitoring events on the cellular comm. network
Correlating an event with specific building, apartment or office according to the details of the subscriber

16. A method for detecting a reason for a problem in the cellular comm. network comprises of:
Collecting a repeating signaling sequence including calls' problem
Analyzing the signaling sequence in conjunction with mapping data to point out the reason for the problem

17. A method as in claim 16 whereas pointing out the reason for the problem is done only with high level signaling data and a mapping data

18. A method as in claim 17 whereas solving network problem further comprises of:
Changing network parameters to solve this problem
